(19) United States
(12) Patent Application Publication
(10) Pub. No.: US 2026/0044598 A1
(43) Pub. Date: Feb. 12, 2026

(54) SYSTEMS AND METHODS OF STORAGE DEVICE SECURITY

(71) Applicant: Samsung Electronics Co., Ltd., Suwon-si (KR)

(72) Inventors: Daniel Lee HELMICK, Thornton, CO (US); Eric HIBBARD, San Jose, CA (US); Michael ALLISON, Prospect, CO (US); Rajesh KOUL, San Jose, CA (US); Joseph FINDLEY, San Jose, CA (US)

(21) Appl. No.: 18/970,888

(22) Filed: Dec. 5, 2024

Related U.S. Application Data
(60) Provisional application No. 63/682,291, filed on Aug. 12, 2024.

(51) Int. Cl. G06F 21/55; G06F 21/57; G06F 21/64

(52) U.S. Cl. CPC G06F 21/554; G06F 21/572; G06F 21/64

(57) ABSTRACT

Provided are systems, methods, and apparatuses for systems and methods of continuous storage device security based on discontinuous states. In one or more examples, the systems, devices, and methods include performing a first attestation of an attribute of a device based on a lapse of time period; comparing the first attestation to a second attestation stored in a buffer; and determining a security status of the device based on comparing the first attestation. The systems, devices, and methods include receiving, from a host at a device, a command; performing a first attestation of an attribute of the device based on a first bit associated with the command indicating to perform the first attestation; storing the first attestation in a first buffer of the host; determining a security status of the device based on the first attestation; and performing a security action based on the security status.

### CROSS-REFERENCE TO RELATED APPLICATIONS

This application claims the benefit of U.S. Provisional Patent Application Ser. No. 63/682,291, filed Aug. 12, 2024, which is incorporated by reference herein for all purposes.

### TECHNICAL FIELD

The subject matter disclosed relates to memory systems. In particular, the subject matter relates to leveraging multiple attestations to enable continuous storage device security through discontinuous states.

### BACKGROUND

The present background section is intended to provide context only, and the disclosure of any concept in this section does not constitute an admission that said concept is prior art.

Data sanitization can include purposely, permanently deleting, or destroying data from a storage device, to ensure the data cannot be recovered. When data is deleted from storage media, the media may not actually be erased, but can be recovered by an attacker who gains access to the device, which raises concerns for security and data privacy.

### SUMMARY

In various embodiments, the systems and methods described herein include systems, methods, and apparatuses for systems and methods of continuous storage device security based on discontinuous states. In some aspects, the techniques described herein relate to a method of persistent attestation, the method including: performing a first attestation of an attribute of a device based on a lapse of a time period (e.g., a configured time period); comparing the first attestation to a second attestation stored in a buffer; determining a security status of the device based on comparing the first attestation; and performing a security action based on the security status.

In some aspects, the techniques described herein relate to a method, further including: performing a third attestation based on a command received by the device; and storing the third attestation in the buffer.

In some aspects, the techniques described herein relate to a method, further including incorporating a transient value in at least one of the first attestation, the second attestation, or the third attestation.

In some aspects, the techniques described herein relate to a method, further including: comparing the third attestation to at least one of the first attestation or the second attestation; and verifying the security status of the device based on comparing the third attestation.

In some aspects, the techniques described herein relate to a method, wherein the command includes at least one of a storage medium sanitize command, a dataset management deallocation command, a storage medium erase command, a storage medium format command, a data read command, a data write command, a virtualization command, a non-volatile memory administrative command, a controller data queue command, a migration receive command, a migration send command, a track send command, or a track receive command.

In some aspects, the techniques described herein relate to a method, wherein the security action comprises at least one of preventing the device from performing an action, isolating at least a portion of the device, limiting access to at least a portion of the device, deactivating at least one hardware component of the device, deactivating at least one software component of the device, or alerting an administrator the device is potentially compromised.

In some aspects, the techniques described herein relate to a method, wherein the command includes a bit that indicates to perform the third attestation.

In some aspects, the techniques described herein relate to a method, further including discarding the first attestation based on a determination that the first attestation matches the second attestation.

In some aspects, the techniques described herein relate to a method, further including storing the first attestation in the buffer based on a determination that the first attestation mismatches the second attestation.

In some aspects, the techniques described herein relate to a method, wherein the attribute of the device includes at least one of an aspect of a device hardware component, an aspect of a device software component, or a device setting.

In some aspects, the techniques described herein relate to a method, wherein: a host of the device includes the buffer, the device includes a storage drive, and performing the first attestation is based on receiving, at the device, an activation command from the host, the activation command activating periodic attestation on the device and indicating the time period.

In some aspects, the techniques described herein relate to a method of persistent attestation, the method including: receiving, from a host at a device, a command; performing a first attestation of an attribute of the device based on a first bit associated with the command indicating to perform the first attestation; storing the first attestation in a first buffer of the host; determining a security status of the device based on the first attestation; and performing a security action based on the security status.

In some aspects, the techniques described herein relate to a method, further including: performing a second attestation of the attribute of the device based on executing the command; and storing the second attestation in a second buffer of the host, wherein determining the security status is based on comparing the first attestation to the second attestation.

In some aspects, the techniques described herein relate to a method, further including incorporating a transient value in at least one of the first attestation or the second attestation, wherein the host or the device comprises the first buffer, and the host or the device comprises the second buffer.

In some aspects, the techniques described herein relate to a method, wherein the command or a submission queue entry associated with the command includes the first bit that indicates to perform the first attestation and a second bit that indicates to perform the second attestation.

In some aspects, the techniques described herein relate to a method, further including blocking at least one other command at the device based on at least one of performing the first attestation, executing the command, or performing the second attestation, wherein the command includes a third bit indicating to block the at least one other command.

In some aspects, the techniques described herein relate to a method, wherein: the command includes a sanitize command, and determining the security status of the device includes verifying, based on the comparing, a firmware image associated with executing the sanitize command.

In some aspects, the techniques described herein relate to a method, wherein: the command includes a firmware update command, and executing the command includes installing a firmware image on the device, the host sending the firmware image to the device with the firmware update command.

In some aspects, the techniques described herein relate to a method, wherein the attribute of the device includes at least one of an aspect of a device hardware component, an aspect of a device software component, or a device setting.

In some aspects, the techniques described herein relate to a non-transitory computer-readable medium storing code that includes instructions executable by a processor to: perform a first attestation of an attribute of a device based on a lapse of a time period (e.g., a configured time period); compare the first attestation to a second attestation stored in a buffer; determine a security status of the device based on comparing the first attestation; and perform a security action based on the security status.

In some aspects, the techniques described herein relate to a non-transitory computer-readable medium, wherein the code includes further instructions executable by the processor to: perform a third attestation based on a command received by the device; store the third attestation in the buffer; and incorporate a transient value in at least one of the first attestation, the second attestation, or the third attestation.

A computer-readable medium is disclosed. The computer-readable medium can store instructions that, when executed by a computer, cause the computer to perform substantially the same or similar operations as described herein are further disclosed. Similarly, non-transitory computer-readable media, devices, and systems for performing substantially the same or similar operations as described herein are further disclosed.

The systems and methods described herein include multiple advantages and benefits. For example, the systems and methods improve storage device security based on improved attestation and authentication. The systems and methods enable attestation and authentication before and/or after a command of heightened security concern. The systems and methods include logging of attestations continuously (e.g., logging when attestations change), thus increasing confidence that a secure channel remains secure by reading the drive's logged attestations. Also, logging of attestations also enables a data center track which components have had an attestation of a firmware image that was discovered to be vulnerable.

### BRIEF DESCRIPTION OF THE DRAWINGS

The above-mentioned aspects and other aspects of the present systems and methods will be better understood when the present application is read in view of the following figures in which like numbers indicate similar or identical elements. Further, the drawings provided herein are for purpose of illustrating certain embodiments only; other embodiments, which may not be explicitly illustrated, are not excluded from the scope of this disclosure.

These and other features and advantages of the present disclosure will be appreciated and understood with reference to the specification, claims, and appended drawings wherein:

FIG. 1 illustrates an example system in accordance with one or more implementations as described herein.

FIG. 2 illustrates details of the system of FIG. 1, according to one or more implementations as described herein.

FIG. 3 depicts a diagram illustrating an example system flow associated with the disclosed systems, in accordance with example implementations described herein.

FIG. 4 depicts a diagram illustrating an example system flow associated with the disclosed systems, in accordance with example implementations described herein.

FIG. 5 depicts a flow diagram illustrating an example method associated with the disclosed systems, in accordance with example implementations described herein.

FIG. 6 depicts a flow diagram illustrating an example method associated with the disclosed systems, in accordance with example implementations described herein.

While the present systems and methods are susceptible to various modifications and alternative forms, specific embodiments thereof are shown by way of example in the drawings and will herein be described. The drawings may not be to scale. It should be understood, however, that the drawings and detailed description thereto are not intended to limit the present systems and methods to the particular form disclosed, but to the contrary, the intention is to cover all modifications, equivalents, and alternatives falling within the spirit and scope of the present systems and methods as defined by the appended claims.

### DETAILED DESCRIPTION OF VARIOUS EMBODIMENTS

The details of one or more embodiments of the subject matter described herein are set forth in the accompanying drawings and the description below. Other features, aspects, and advantages of the subject matter will become apparent from the description, the drawings, and the claims.

Various embodiments of the present disclosure now will be described more fully hereinafter with reference to the accompanying drawings, in which some, but not all embodiments are shown. Indeed, the disclosure may be embodied in many forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Like numbers refer to like elements throughout. Arrows in each of the figures depict bi-directional data flow and/or bi-directional data flow capabilities. The terms “path,” “pathway” and “route” are used interchangeably herein.

Embodiments of the present disclosure may be implemented in various ways, including as computer program products that comprise articles of manufacture. A computer program product may include a non-transitory computer-readable storage medium storing applications, programs, program components, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (for example a solid-state drive (SSD)), solid state card (SSC), solid state module (SSM), enterprise flash drive, magnetic tape, or any other non-transitory magnetic medium, and/or the like. A non-volatile computer-readable storage medium may include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may include read-only memory (ROM), programmable read-only memory (PROM), erasable programmable read-only memory (EPROM), electrically erasable programmable read-only memory (EEPROM), flash memory (for example Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory component (RIMM), dual in-line memory component (DIMM), single in-line memory component (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of a hardware embodiment, a computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, a hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially, such that one instruction is retrieved, loaded, and executed at a time. In some example embodiments, retrieval, loading, and/or execution may be performed in parallel, such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not be necessarily all referring to the same embodiment. Furthermore, the particular features, structures or characteristics may be combined in any suitable manner in one or more embodiments. In this regard, as used herein, the word “exemplary” means “serving as an example, instance, or illustration. ” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. Similarly, various waveforms and timing diagrams are shown for illustrative purpose only. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on chip (SoC), an assembly, and so forth.

The following description is presented to enable one of ordinary skill in the art to make and use the subject matter disclosed herein and to incorporate it in the context of particular applications. While the following is directed to specific examples, other and further examples may be devised without departing from the basic scope thereof.

Various modifications, as well as a variety of uses in different applications, will be readily apparent to those skilled in the art, and the general principles defined herein may be applied to a wide range of embodiments. Thus, the subject matter disclosed herein is not intended to be limited to the embodiments presented, but is to be accorded the widest scope consistent with the principles and novel features disclosed herein.

In the description provided, numerous specific details are set forth in order to provide a more thorough understanding of the subject matter disclosed herein. It will, however, be apparent to one skilled in the art that the subject matter disclosed herein may be practiced without necessarily being limited to these specific details. In other instances, well-known structures and devices are shown in block diagram form, rather than in detail, in order to avoid obscuring the subject matter disclosed herein.

All the features disclosed in this specification (e.g., any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Various features are described herein with reference to the figures. It should be noted that the figures are only intended to facilitate the description of the features. The various features described are not intended as an exhaustive description of the subject matter disclosed herein or as a limitation on the scope of the subject matter disclosed herein. Additionally, an illustrated example need not have all the aspects or advantages shown. An aspect or an advantage described in conjunction with a particular example is not necessarily limited to that example and can be practiced in any other examples even if not so illustrated, or if not so explicitly described.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

It is noted that, if used, the labels left, right, front, back, top, bottom, forward, reverse, clockwise and counterclockwise have been used for convenience purposes only and are not intended to imply any particular fixed direction. Instead, the labels are used to reflect relative locations and/or directions between various portions of an object.

Data processing may include data buffering, aligning incoming data from multiple communication lanes, forward error correction (FEC), etc. For example, data may be received by an analog front end (AFE), which can prepare the incoming data for digital processing. The digital portion of the transceivers (e.g., digital signal processor (DSP)) may provide skew management, equalization, reflection cancellation, and/or other functions. It is to be appreciated that the process described herein can provide many benefits, including saving both power and cost.

Moreover, the terms “system,” “component,” “module,” “interface,” “model,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless explicitly stated otherwise, each numerical value and range may be interpreted as being approximate, as if the word “about” or “approximately” preceded the value of the value or range. Signals and corresponding nodes or ports might be referred to by the same name and are interchangeable for purposes here.

While embodiments may have been described with respect to circuit functions, the embodiments of the subject matter disclosed herein are not limited. Possible implementations may be embodied in a single integrated circuit, a multi-chip module, a single card, SoC, or a multi-card circuit pack. As would be apparent to one skilled in the art, the various embodiments might also be implemented as part of a larger system. Such embodiments may be employed in conjunction with, for example, a digital signal processor, microcontroller, field-programmable gate array, application-specific integrated circuit, or general-purpose computer.

As would be apparent to one skilled in the art, various functions of circuit elements may also be implemented as processing blocks in a software program. Such software may be employed in, for example, a digital signal processor, microcontroller, or general-purpose computer. Such software may be embodied in the form of program code embodied in tangible media, such as magnetic recording media, optical recording media, solid-state memory, floppy diskettes, CD-ROMs, hard drives, or any other non-transitory machine-readable storage medium, that when the program code is loaded into and executed by a machine, such as a computer, the machine becomes an apparatus for practicing the subject matter disclosed herein. When implemented on a general-purpose processor, the program code segments combine with the processor to provide a unique device that operates analogously to specific logic circuits. Described embodiments may also be manifest in the form of a bit stream or other sequence of signal values electrically or optically transmitted through a medium, stored magnetic-field variations in a magnetic recording medium, etc., generated using a method and/or an apparatus as described herein.

The systems and methods described herein may include and/or may be based on solid-state drives (SSDs). SSDs can include storage devices used in computers that store data on solid-state flash memory (e.g., NAND flash memory). NAND flash is a non-volatile storage technology that stores data without requiring power. NAND flash may be referred to as a memory chip. Flash memory cards and SSDs use multiple NAND flash memory chips to store data. In data management, “hot” data is data that is frequently accessed and/or in high demand, while “cold” data includes data that is infrequently accessed and/or infrequently in demand (e.g., set and forget data).

SSDs can work with a computer's memory (e.g., random-access memory (RAM)) and processor to access and use data. This includes files like operating systems, programs, documents, games, images, media, etc. SSDs are permanent or non-volatile storage devices, meaning SSDs maintain stored data even when power to the computer is off. SSDs may be used as secondary storage in a computer's storage hierarchy. The systems and methods described herein may include and/or may be based on RAM-based SSDs. RAM-based SSDs can include silicon microchips and use dynamic RAM (DRAM) or static RAM chips to store data electronically. RAM-based SSDs can be used for write-intensive workloads and offer better performance and endurance than flash-based SSDs.

The systems and methods described herein may include and/or may be based on non-volatile memory express (NVMe®), such as NVMe SSDs. NVMe can be a data transfer protocol that may be configured to connect SSD storage to servers and/or processors using the PCIe bus. NVMe was created to improve speed and performance of computer systems. An NVMe controller can include a logical-device interface specification that allows access to a computer's non-volatile storage media. NVMe controllers are optimized for high-performance random read/write operations. In some cases, the NVMe controller can perform flash management operations of an SSD on-chip, while consuming negligible host processing and memory resources. NVMe can perform parallel input/output (I/O) operations with multicore processors to facilitate high throughput. NVMe controllers can map I/O and responses to shared memory in a host computer over a PCIe interface. In some cases, NVMe controllers can communicate directly with a host central processing unit (CPU). The systems and methods described herein may include and/or may be based on an NVMe namespace. An NVMe namespace can include a collection of LBAs accessible to a host. A namespace ID (NSID) can be an identifier used by a controller to provide access to a namespace.

The systems and methods described herein may include and/or may be based on attestation. Attestation can include processes in computing that verify the authenticity and integrity of a system's hardware components, software components, and/or device settings. Attestation can establish trust in computing technologies, which are used in everything from smartphones to critical infrastructure. Attestation may be referred to as authentication (e.g., attestation and authentication) based on the attestation/authentication providing verification of the authenticity and integrity of a system's hardware components, software components, and/or device settings. Attestation may include a process of providing a digital signature for a set of measurements securely stored in hardware (e.g., processor, memory, storage, network interface card, etc.), and validating the digital signature and the set of measurements. In some examples, attestations of computer hardware may be performed through a series of steps that may involve a host, a host system, hardware of the host system, a server, etc. In some examples, a host may send a request to an attestation server. The attestation server may respond with a challenge, which may include a nonce to prevent replay attacks. The host may submit evidence that combines elements of the challenge with data from the host (e.g., hardware components of the host). The evidence may be digitally signed with a key that is only known to the hardware root-of-trust. The attestation server may compare the host's measurements against a trusted set of measurements provided by the server (e.g., via a third-party attestation service, third party digital-signature service). If the measurements match, the server may notify the host that that the host's system has not been compromised. Accordingly, attestation allows parties to establish trust in a system's hardware, software, and configurations. Some attestation schemes may use hardware-based security modules, such as the Trusted Platform Module (TPM). A TPM may include a microcontroller that uses cryptographic keys to secure hardware.

The systems and methods described herein may include and/or may be based on one or more security protocols, encryption protocols, etc., such as transport layer security (TLS). TLS can include a security protocol used to encrypt communications, such as communications over the Internet. TLS can use two types of key-based encryption techniques: symmetric encryption, which uses the same key to encrypt and decrypt data, and asymmetric encryption, which uses both a public and private key.

The systems and methods described herein may be based on and/or include data sanitization. Data sanitization can include processes that are aimed to prevent deleted data being accessed (e.g., even with advanced forensic methods). There are several methods of data sanitization. Degaussing can include altering the magnetic field and/or randomizing data of storage mediums, such as hard-disk drives and tape drives. Physical destruction can include mechanically shredding storage devices into small pieces using mechanical shredders or degaussers. Cryptographic erasure can make data unrecoverable when the proper steps are taken and verification and certification are achieved. Overwriting can include replacing stored data with random ones and zeroes, where devices can remain reusable. Secure erase can include firmware commands to completely erase data from a device. Block erase can include using internal SSD functions to electronically erase each block of an SSD or other flash-memory-based device. Wiping or clearing can include overwriting a drive's storage blocks by zeroing out or randomizing the stored data. Purging can include using physical or logical techniques that renders target data recovery infeasible based on implementing overwrite, block erase, and cryptographic erase methods.

Storage sanitization (e.g., media-based sanitization) can take the form of purge sanitization methods, such as cryptographic erase and destruct sanitization methods, such as shredding, incineration, etc. Some users (e.g., hyperscalers) may use destruction as a default method. Destruction can be performed easily on-site, avoiding issues where loss of control/possession of the storage drives could result in data breaches. Also, with destruction, evidence of destruction is straightforward (e.g., pictures of destroyed drives). Also, there is no special expertise or systems required for destruction (e.g., easily outsourced).

Issues exist with some sanitization systems. For example, some sanitization systems provide no visibility when a bad actor takes over a drive after the last attestation and authentication. Also, data safety concerns exist for sanitize operations in relation to risks associated with firmware updates. In some cases, attestation and authentication can be executed at the time a drive is booted. However, a drive may run for a relatively long time after the drive was booted (e.g., a relatively long time since attestation and authentication). Accordingly, there is a relatively high potential that the drive could be hacked during this time.

Issues with circular economic system and environmental, social, and governance (ESG) concerns are potentially changing the method of choice for storage sanitization (e.g., away from destruction and towards purging, for example). Some concerns of non-destructive methods include proof of data eradication, the reliability/integrity of purge methods, and the trustworthiness of systems doing sanitization.

Additional issues with non-destruct sanitization include determining whether a sanitization mechanism is valid at the time it is invoked and enabling customers to verify that a sanitization mechanism is valid. In some cases, firmware/hardware may perform checks prior to sanitization, where a sanitization success indication may be based simply on the firmware/hardware indicating “sanitization command completed successfully. ” Additional issues with non-destruct sanitization include determining whether hot fixes of firmware are to be considered from a sanitization perspective; whether sanitization mechanisms should be disabled until reboot/reset and firmware validation; how to avoid timing issues (e.g., between firmware check and sanitization invocation). In some cases, bundled commands and/or embedded commands may be used as part of sanitization invocations.

The systems and methods described herein may include and/or may be based on dataset management (DSM) commands. A DSM command (e.g., from a host to a storage device) may be used by the host to indicate attributes for ranges of logical blocks, such as frequency that data is read or written, access size, and other information that may be used to optimize performance and reliability. DSM commands may be sent from a host to a storage drive to deallocate or trim a section of data. TRIM commands (e.g., from host) inform the storage drive that a specific area of data is no longer in use. DSM deallocation can include releasing resources allocated to a program, such as data sets, control files, etc.

The systems and methods described herein may be based on and/or include cloud computing. Cloud computing can include the use of hosted services, such as data storage, servers, databases, networking, and software over the internet. Cloud computing can include the delivery of computing services (e.g., servers, storage, databases, networking, software, analytics, intelligence, etc.) over the Internet to offer flexible resources and economies of scale. The systems and methods described herein may be based on and/or include cloud hyperscalers. Cloud hyperscalers can include cloud service providers that run large data center networks to offer computing, storage, and other IT services to businesses and independent software vendors. Hyperscalers can be similar to traditional data centers, but on a much larger scale. Hyperscalers can build and manage relatively large hardware and software infrastructures in their facilities, which can include millions of servers spread across many data centers, providing seemingly endless storage and computing resources that can meet the demands of millions or even billions of users.

The systems and methods may include performing one or more security actions based on attestations. As used herein, the term “security action” may refer to any number of actions the systems described herein may take after determining that a device (e.g., storage drive) may be comprised (e.g., with malware). For example, types of security actions may include preventing the device from performing an action (e.g., process read command, process write command, process erase command, perform allocation, perform deallocation), alerting an administrator to the potentially compromised device, isolating at least a portion of the device, limiting access to the device (limiting read access to at least a portion of the device, limiting read access to at least a portion of the device), deactivating at least a portion (e.g., one or more hardware components, one or more software components) of the device, locking at least a portion of the device (e.g., blocking access, deactivating) until an administrator clears the lock, and the like. Thus, the security actions in conjunction with the methods and systems described herein may improve the security and operating integrity of one or more computing devices by protecting the hardware, firmware, software, or any combination thereof of the one or more computing devices from malicious attack. It should be appreciated that these are not exhaustive lists of the types of security actions which may be performed by the systems described herein.

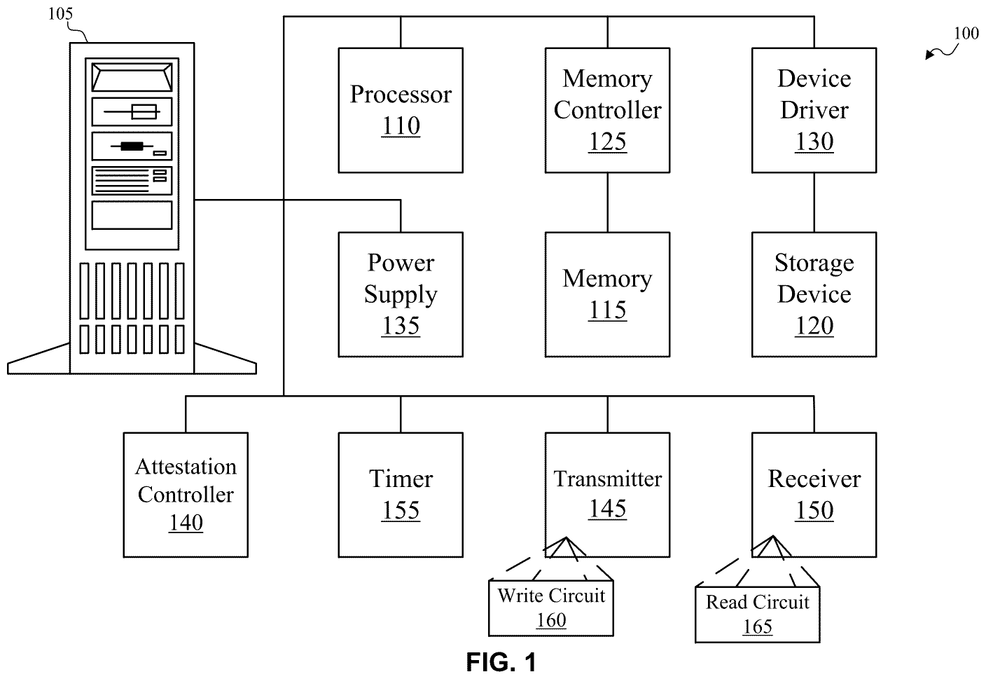

FIG. 1 illustrates an example system 100 in accordance with one or more implementations as described herein. In FIG. 1, machine 105, which may be termed a host, a system, or a server, is shown. While FIG. 1 depicts machine 105 as a tower computer, embodiments of the disclosure may extend to any form factor or type of machine. For example, machine 105 may be a rack server, a blade server, a desktop computer, a tower computer, a mini tower computer, a desktop server, a laptop computer, a notebook computer, a tablet computer, etc.

Machine 105 may include processor 110, memory 115, and storage device 120. Processor 110 may be any variety of processor. It is noted that processor 110, along with the other components discussed below, are shown outside the machine for ease of illustration: embodiments of the disclosure may include these components within the machine. While FIG. 1 shows a single processor 110, machine 105 may include any number of processors, each of which may be single core or multi-core processors, each of which may implement a Reduced Instruction Set Computer (RISC) architecture or a Complex Instruction Set Computer (CISC) architecture (among other possibilities), and may be mixed in any desired combination.

Processor 110 may be coupled to memory 115. Memory 115 may be any variety of memory, such as flash memory, Dynamic Random Access Memory (DRAM), Static Random Access Memory (SRAM), Persistent Random Access Memory, Ferroelectric Random Access Memory (FRAM), or Non-Volatile Random Access Memory (NVRAM), such as Magnetoresistive Random Access Memory (MRAM), Phase Change Memory (PCM), or Resistive Random-Access Memory (ReRAM). Memory 115 may include volatile and/or non-volatile memory. Memory 115 may use any desired form factor: for example, Single In-Line Memory Module (SIMM), Dual In-Line Memory Module (DIMM), Non-Volatile DIMM (NVDIMM), etc. Memory 115 may be any desired combination of different memory types, and may be managed by memory controller 125. Memory 115 may be used to store data that may be termed “short-term”: that is, data not expected to be stored for extended periods of time. Examples of short-term data may include temporary files, data being used locally by applications (which may have been copied from other storage locations), and the like.

Processor 110 and memory 115 may support an operating system under which various applications may be running. These applications may issue requests (which may be termed commands) to read data from or write data to either memory 115 or storage device 120. When storage device 120 is used to support applications reading or writing data via some sort of file system, storage device 120 may be accessed using device driver 130. While FIG. 1 shows one storage device 120, there may be any number (one or more) of storage devices in machine 105. Storage device 120 may support any desired protocol or protocols, including, for example, the Non-Volatile Memory Express (NVMe) protocol, a Serial Attached Small Computer System Interface (SCSI) (SAS) protocol, or a Serial AT Attachment (SATA) protocol. Storage device 120 may include any desired interface, including, for example, a Peripheral Component Interconnect Express (PCIe) interface, or a Compute Express Link (CXL) interface. Storage device 120 may take any desired form factor, including, for example, a U.2 form factor, a U.3 form factor, a M.2 form factor, Enterprise and Data Center Standard Form Factor (EDSFF) (including all of its varieties, such as E1 short, E1 long, and the E3 varieties), or an Add-In Card (AIC).

While FIG. 1 uses the term “storage device,” embodiments of the disclosure may include any storage device formats that may benefit from the use of computational storage units, examples of which may include hard disk drives, Solid State Drives (SSDs), or persistent memory devices, such as PCM, ReRAM, or MRAM. Any reference to “storage device” “SSD” below should be understood to include such other embodiments of the disclosure and other varieties of storage devices. In some cases, the term “storage unit” may encompass storage device 120 and memory 115. Machine 105 may include power supply 135. Power supply 135 may provide power to machine 105 and its components.

Machine 105 may include transmitter 145 and receiver 150. Transmitter 145 or receiver 150 may be respectively used to transmit or receive data. In some cases, transmitter 145 and/or receiver 150 may be used to communicate with memory 115 and/or storage device 120. Transmitter 145 may include write circuit 160, which may be used to write data into storage, such as a register, in memory 115 and/or storage device 120. In a similar manner, receiver 150 may include read circuit 165, which may be used to read data from storage, such as a register, from memory 115 and/or storage device 120.

In the illustrated example, machine 105 may include timer 155, which may be used to time one or more operations, indicate a time period, indicate a lapse of time, indicate an expiration, indicate a timeout, etc. For example, timer 155 may provide a time period for periodic attestation or indicate a lapse of a time period for periodic attestation, etc.

In one or more examples, machine 105 may be implemented with any type of apparatus. Machine 105 may be configured as (e.g., as a host of) one or more of a server such as a compute server, a storage server, storage node, a network server, a supercomputer, data center system, and/or the like, or any combination thereof. Additionally, or alternatively, machine 105 may be configured as (e.g., as a host of) one or more of a computer such as a workstation, a personal computer, a tablet, a smartphone, and/or the like, or any combination thereof. Machine 105 may be implemented with any type of apparatus that may be configured as a device including, for example, an accelerator device, a storage device, a network device, a memory expansion and/or buffer device, a central processing unit (CPU), a graphics processing unit (GPU), a neural processing unit (NPU), a tensor processing unit (TPU), optical processing units (OPU), and/or the like, or any combination thereof.

Any communication between devices including machine 105 (e.g., host, computational storage device, and/or any intermediary device) can occur over an interface that may be implemented with any type of wired and/or wireless communication medium, interface, protocol, and/or the like including PCIe, NVMe, Ethernet, NVMe-oF, Compute Express Link (CXL), and/or a coherent protocol such as CXL.mem, CXL.cache, CXL.IO and/or the like, Gen-Z, Open Coherent Accelerator Processor Interface (OpenCAPI), Cache Coherent Interconnect for Accelerators (CCIX), Advanced eXtensible Interface (AXI) and/or the like, or any combination thereof, Transmission Control Protocol/Internet Protocol (TCP/IP), FibreChannel, InfiniBand, Serial AT Attachment (SATA), Small Computer Systems Interface (SCSI), Serial Attached SCSI (SAS), iWARP, any generation of wireless network including 2G, 3G, 4G, 5G, and/or the like, any generation of Wi-Fi, Bluetooth, near-field communication (NFC), and/or the like, or any combination thereof. In some embodiments, the communication interfaces may include a communication fabric including one or more links, buses, switches, hubs, nodes, routers, translators, repeaters, and/or the like. In some embodiments, system 100 may include one or more additional apparatus having one or more additional communication interfaces.

Any of the functionality described herein, including any of the host functionality, device functionally, attestation controller 140 functionality, and/or the like, may be implemented with hardware, software, firmware, or any combination thereof including, for example, hardware and/or software combinational logic, sequential logic, timers, counters, registers, state machines, volatile memories such as at least one of or any combination of the following: dynamic random access memory (DRAM) and/or static random access memory (SRAM), nonvolatile memory including flash memory, persistent memory such as cross-gridded nonvolatile memory, memory with bulk resistance change, phase change memory (PCM), and/or the like and/or any combination thereof, complex programmable logic devices (CPLDs), field programmable gate arrays (FPGAs), application specific integrated circuits (ASICs) CPUs including complex instruction set computer (CISC) processors such as x86 processors and/or reduced instruction set computer (RISC) processors such as RISC-V and/or ARM processors), GPUs, NPUs, TPUs, OPUs, and/or the like, executing instructions stored in any type of memory. In some embodiments, one or more components of attestation controller 140 may be implemented as an SoC.

In some examples, attestation controller 140 may include any one or combination of logic (e.g., logical circuit), hardware (e.g., processing unit, memory, storage), software, firmware, and the like. In some cases, attestation controller 140 may perform one or more functions in conjunction with processor 110. In some cases, at least a portion of attestation controller 140 may be implemented in or by processor 110 and/or memory 115. The one or more logic circuits of attestation controller 140 may include any one or combination of multiplexers, registers, logic gates, arithmetic logic units (ALUs), cache, computer memory, microprocessors, processing units (CPUs, GPUs, NPUs, and/or TPUs), FPGAs, ASICs, etc., that enable attestation controller 140 to provide systems and methods of continuous storage device security based on discontinuous states.

In one or more examples, attestation controller 140 may perform a first attestation of an attribute of a device based on a lapse of a configured time period; compare the first attestation to a second attestation stored in a buffer; and/or determine a security status of the device based on comparing the first attestation. In some cases, attestation controller 140 may receive, from a host at a device, a command; perform a first attestation of an attribute of the device based on a first bit associated with the command indicating to perform the first attestation; store the first attestation in a first buffer of the host; and/or determine a security status of the device based on the first attestation. In some cases, attestation controller 140 may be at least partially implemented in processor 110. Additionally, or alternatively, attestation controller 140 may be at least partially implemented in storage device 120 (e.g., in a computational storage drive).

A given storage drive (e.g., storage device 120) can include hardware (e.g., storage medium, NAND flash, etc.), settings (e.g., hardware configuration parameters), and firmware. Attestations can include taking a snapshot of a state of the storage drive (e.g., state of hardware, state of settings, and/or state of firmware). If a host or the storage drive determines that at least one of those states has changed (e.g., changed unexpectedly), then the attestation has changed, indicating a discontinuous state. Thus, discontinuous states can result in gaps in attestation (e.g., the unexpected change or the difference between the snapshot and the unexpected change), which can result in or allow bad actors performing malicious actions on the storage drive. Based on the systems and methods described herein, the attestation controller 140 closes such gaps in attestations where bad actor can introduce malware.

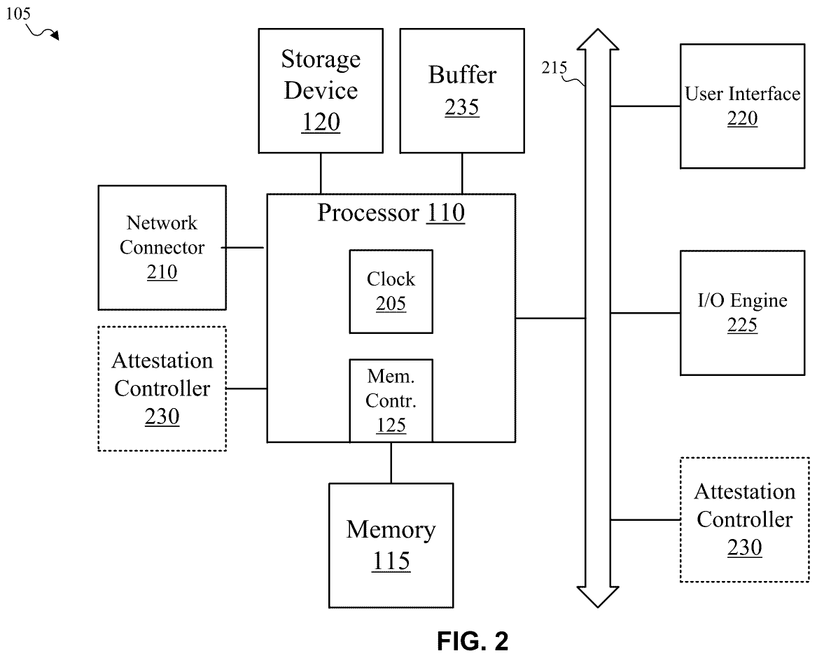

FIG. 2 illustrates details of machine 105 of FIG. 1, according to examples described herein. In the illustrated example, machine 105 may include processor 110. Processor 110 may include one or more processors and/or one or more dies. Processor 110 may include memory controller 125 (e.g., one or more memory controllers) and clock 205 (e.g., one or more clocks), which may be used to coordinate the operations of the components of the machine. Processor 110 may be coupled to memory 115 (e.g., one or more memory chips, stacked memory, etc.), which may include random access memory (RAM), read-only memory (ROM), or other state preserving media, as examples. Processor 110 may be coupled to storage device 120 (e.g., one or more storage devices), and to network connector 210, which may be, for example, an Ethernet connector or a wireless connector.

As shown, processor 110 may be connected to bus 215 (e.g., one or more buses), to which may be attached user interface 220 (e.g., one or more user interfaces) and Input/Output (I/O) interface ports that may be managed using I/O engine 225 (e.g., one or more I/O engines), among other components. As shown, processor 110 may be coupled to attestation controller 230, which may be an example of attestation controller 140 of FIG. 1. Additionally, or alternatively, processor 110 may be connected to bus 215, to which may be attached attestation controller 230. As shown, processor 110 may be coupled to buffer 235 (e.g., one or more buffers, a first buffer, a second buffer, etc.). In some examples, processor 110 may include at least a portion of buffer 235 (e.g., a buffer in a cache of processor 110). Buffer 235 enables the systems and methods described herein to be implemented across a more diverse set of devices and device states. For example, buffer 235 enables the systems and methods to be implemented based on a restart, restart after power loss, and/or idles states. For example, attestation controller 230 may be configured to perform an attestation before a restart and/or perform an attestation after restart, where attestation controller 230 stores at least one attestation in a buffer (e.g., buffer 235). After restart, attestation controller 230 may perform an attestation and compare the attestation to another attestation stored in buffer 235.

The systems and methods described herein may include performing one or more operations that improve data security of storage drives (e.g., storage device 120). In some examples, the systems and methods may attest and authenticate a storage drive before and/or after concern points (e.g., before and/or after certain commands). In some cases, a host may be concerned about what firmware (e.g., firmware version, firmware source) is executing a given command. For some commands, the systems and methods may include executing at least one attestation before the command is executed by the firmware. The systems and methods may include performing an attestation before a sanitize command, a deallocation (e.g., DSM deallocate), an erase command, and/or other Privileged Commands. The systems and methods described may be implemented for multiple types of storage commands (e.g., Erase, Format, Deallocate, etc.).

The systems and methods may be implemented based on one or more privileged commands, where at least one attestation is performed before and/or after a privilege command is executed by firmware on the storage device. Examples of privileged commands may include administrative commands such as namespace (NS) management, NS attachment, virtualization management, format NVM (e.g., to change the block size of an NVMe device), set features (e.g., based on feature identifier, sanitize configuration), sanitize capacity management, controller data queue, migration receive, migration send, track send, track receive, etc. In some cases, privilege commands can include property writes including NVM subsystem reset, vendor specific commands, and the like.

The systems and methods described herein may include performing one or more operations that improve storage sanitization. In some cases, a host may be concerned about what firmware is executing a given command. For some commands, the systems and methods may include executing at least one attestation before the command is executed by the firmware. In some cases, the systems and methods may include executing at least one attestation after the command is executed by the firmware.

The systems and methods may include performing an attestation before and after commands for firmware updates. In some cases, the systems and methods the attestations can verify the current firmware and/or the update firmware (e.g., version, source) before updating the firmware, verify the current firmware and/or the update firmware after updating the firmware, etc. A follow up attestation after the firmware update may be performed to confirm the firmware update is stable and security is not sacrificed. In some cases, the systems and methods may include performing an attestation before and after commands for sanitize verification (e.g., post sanitize verification), to prove firmware stability before and after sanitization. In some cases, the systems and methods may include performing an attestation before and after commands for command lock down to prove firmware stability before and after sanitization the command lock down. In some cases, the systems and methods may include performing an attestation before and after commands associated with Multiple Device Personality to prove firmware stability before and after firmware transitions. In some cases, the systems and methods may include performing an attestation before and after commands associated with reverting a storage device to manufacturing defaults, to prove firmware stability before and after reverting the device to the manufacturing defaults.

The systems and methods may be extended to continuously logged attestations. In some examples, the systems and methods may be based on an assumption that secure channels (e.g., TLS) do not remain secure. TLS keys may be used to secure communications. The older a TLS key is, the more likely the TLS key may be compromised. If a key becomes compromised, then a bad actor may gain access to a system. If a bad actor gains access to a system, then hardware/software components may be compromised. Accordingly, the systems and methods may include periodically renegotiating encryption keys (e.g., TLS keys). Logging of attestations continuously (e.g., logging when attestations change) increases confidence that a secure channel stays secure by storing the logged attestations and enabling the reading of the drive's logged attestations (e.g., by system administrator, by end user, third party, etc.). Logging of attestations also enables a data center to track which components have had an attestation of a firmware image that was discovered to be vulnerable at any point in time.

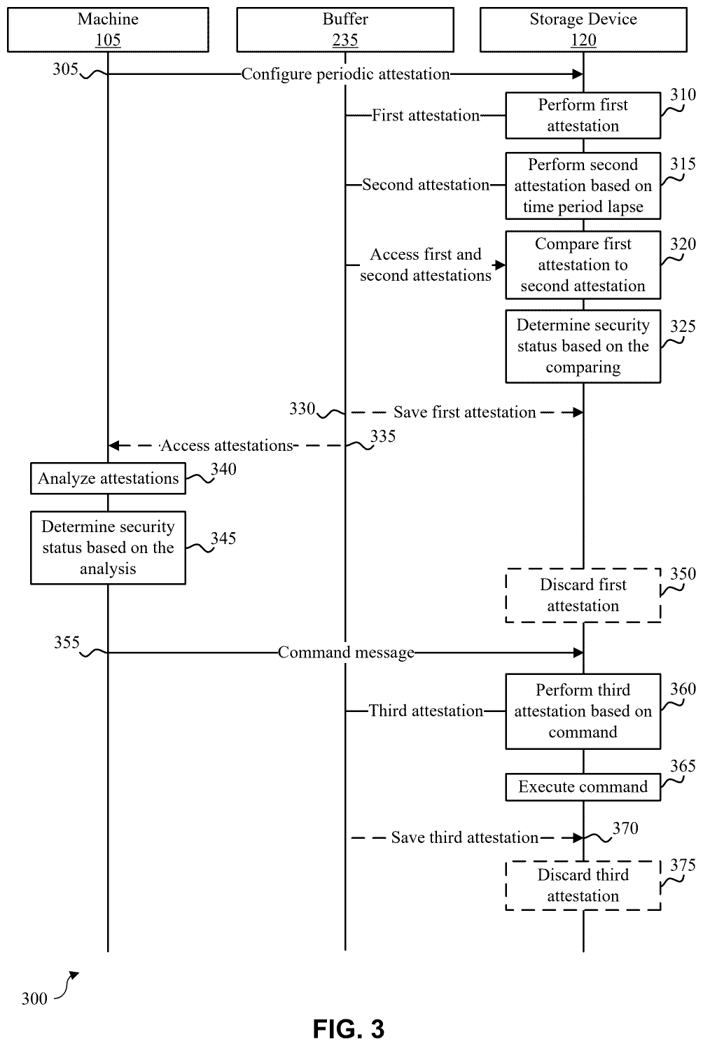

FIG. 3 illustrates an example system flow 300 in accordance with one or more implementations as described herein. In some configurations, one or more aspects of system flow 300 may be implemented by or in conjunction with attestation controller 140 of FIG. 1 and/or attestation controller 230 of FIG. 2. In some configurations, one or more aspects of system flow 300 may be implemented by or in conjunction with machine 105, components of machine 105, or any combination thereof. As shown, system flow 300 may include machine 105 (e.g., a host device), buffer 235, and storage device 120. In some cases, machine 105 may be a host of storage device 120. In some cases, machine 105 may include one or more buffers (e.g., attestation buffers) that include buffer 235. It is noted that buffer 235 may be located on storage device 120 or on the host (e.g., machine 105). System flow 300 may depict storage device 120 performing attestation into buffer 235. The systems and methods described herein may enable storage device 120 and/or the host (e.g., machine 105) to read the attestations out of the buffer space of buffer 235 for the purposes of doing analysis (e.g., comparison of attestations). Buffer 235 can reside in storage device 120 or machine 105. The operation of reading attestations may be similar to a memory read, (e.g., a device log page query; a read command to a new LBA space; a read from a subsystem local memory location, etc.).

At 305, machine 105 may configure storage device 120 for periodic attestation. In some cases, machine 105 may send one or more configuration messages to storage device 120. In some cases, at least one configuration message may configure storage device 120 to active periodic attestation (e.g., to activate or deactivate periodic attestation). In some cases, the one or more configuration messages may provide a time period for periodic attestation (e.g., perform an attestation every hour, every day, every week, etc.). In some cases, the one or more configuration messages may indicate to perform periodic attestation on hardware components, software components, and/or device settings of storage device 120. In some cases, the one or more configuration messages may indicate a first time period for hardware components, a second time period for software components, and/or a third time period for device settings. In some cases, the second time period may be different from the first time period. In some cases, the third time period may be different from the first time period and/or the second time period. In some cases, storage device 120 may select at least one time period for periodic attestation. In some cases, configuration of storage device 120 may include commands for which attestation may be done in advance of execution in addition to or in the alternative to one or more time periods.

At 310, storage device 120 may perform a first attestation. For example, storage device 120 may perform at least a first attestation based on an attestation configuration (e.g., independent of a time-based or periodic attestation; an initial attestation; a benchmark attestation).

At 315, storage device 120 may perform a second attestation. In some cases, the second attestation may be performed based on a lapsing of the configured time period. For example, storage device 120 may perform at least a first attestation based on storage device 120 determining the time period has lapsed.

At 320, storage device 120 may compare the first attestation to a second attestation. In some cases, storage device 120 may access the second attestation stored in buffer 235 (e.g., read the attestations from buffer 235 to do the comparing).

At 325, storage device 120 may determine a security status based on comparing the first attestation to the second attestation. In some cases, the security status may indicate whether storage device 120 is secure, remains secure, is compromised, etc. In some cases, machine 105 may determine a security status of storage device 120 based on comparing the first attestation to the second attestation.

At 330, storage device 120 may optionally save the first attestation. For example, storage device 120 may save the first attestation based on determining that the first attestation does not match the second attestation.

At 335, machine 105 may access one or more attestations. For example, machine 105 may access the first attestation and the second attestation.

At 340, machine 105 may analyze one or more attestations. For example, machine 105 may analyze the first attestation and the second attestation (e.g., the second attestation in buffer 235, the first attestation in buffer 235 or saved to another buffer of machine 105). Analysis may include comparing a first attestation to a second attestation to determine whether they match or they differ. A matching attestation may indicate the device is secure. A mismatch may indicate the device may be compromised.

At 345, machine 105 may determine a security status based on the analysis at 340. In some cases, machine 105 may perform one or more operations (e.g., device and/or data security operations) based on the analysis. When the analysis indicates that the first attestation does not match the second attestation, the storage device 120 and/or machine 105 may determine that storage device 120 may not be in a secure state. Accordingly, machine 105 may analyze one or more aspects of storage device 120 to determine whether the security or operational integrity of storage device 120 has been compromised. For example, machine 105 may analyze a function of storage device 120 (e.g., write command, read command, allocation command, deallocation command) to determine whether the storage drive performs as expected. In some cases, machine 105 may run a test that verifies one or more functions of the storage device 120. In some cases, machine 105 may compare one or more aspects of a firmware of storage device 120 to a known-good version of the same firmware. In some cases, machine 105 may run malware analysis on the firmware of storage device 120 In some cases, when machine 105 determines storage device 120 is compromised or more than likely is compromised based on a failed attestation (e.g., mismatched attestations), machine 105 may isolate or deactivate one or more components of storage device 120, turn off storage device 120, install a flash image update, undo a flash image update, etc. In some cases, one or more operations of 335, 340, and/or 345 may be performed in parallel with one or more operations of storage device 120 and/or buffer 235 depicted in system flow 300.

At 350, storage device 120 may optionally discard the first attestation. For example, storage device 120 may discard the first attestation based on determining that the first attestation matches the second attestation. When the first attestation matches the second attestation, the storage device 120 and/or machine 105 may determine that storage device 120 remains in a secure state. The storage device 120 may keep the second attestation for some time (e.g., indefinitely) or until an authorized changes such as a firmware update, which may result in an updated attestation.

At 355, machine 105 may send a command to storage device 120. The command may include at least one of a storage medium sanitize command, a dataset management deallocation command, a storage medium erase command, a storage medium format command, a data read command, a data write command, a virtualization command, a non-volatile memory administrative command, a controller data queue command, a migration receive command, a migration send command, a track send command, a track receive command, etc.

At 360, storage device 120 may perform a third attestation based on the command. In some examples, the command may include a bit that instructs storage device 120 to perform the third attestation before executing the command. In some cases, the command may include a second bit that instructs storage device 120 to perform a fourth attestation after executing the command. In some cases, a submission queue entry associated with the command may include the bit for the third attestation and/or the bit for the fourth attestation.

At 365, storage device 120 may execute the command. In some cases, storage device 120 may block one or more other commands based on the third attestation, based on executing the command, and/or based on the fourth attestation. For example, one or more bits included in the command and/or one or more bits included in a submission queue entry associated with the command may indicate to block one or more commands while performing the third attestation, to block one or more commands while executing the command, and/or to block one or more commands while performing the fourth attestation.

At 370, storage device 120 may optionally save the third attestation. For example, storage device 120 may save the third attestation based on determining that the third attestation does not match another attestation. In some cases, machine 105 may access one or more attestations. For example, machine 105 may access at least the third attestation. In some examples, machine 105 may analyze the third attestation in relation to at least one other attestation (e.g., first attestation, second attestation). In some cases, machine 105 may determine a security status based on the analysis of the third attestation. In some cases, machine 105 may perform one or more operations (e.g., device and/or data security operations) based on the analysis of the third attestation (e.g., discard third attestation based on analysis of third attestation).

At 375, storage device 120 may optionally discard the third attestation. For example, storage device 120 may discard the third attestation based on determining that the third attestation matches the second attestation or the first attestation. When the third attestation matches a saved attestation (e.g., saved in buffer 235), the storage device 120 and/or machine 105 may determine that storage device 120 remains in a secure state. If determined to not be secure, storage device 120 or machine 105 may stop the command from continuing (e.g., error originating command; hold command and send an Advanced Error Notification (AEN) back to machine, etc.).

In some cases, a transient value (e.g., timestamp, current time, current date and time, etc.) may be incorporated in an attestation. By incorporating the transient value, a potential bad actor may be prevented from copying or using an old attestation as if it were a current attestation. For example, a host (e.g., machine 105) and/or storage drive (e.g., storage device 120) may confirm the transient value incorporated in an attestation when verifying the attestation. When the host or storage drive determines the transient value is valid based on the transient value, then the attestation may be accepted. When the host or storage drive determines the transient value is invalid, then the attestation may be rejected. In some examples, neither a host (e.g., machine 105) nor a storage device (e.g., storage device 120) may be required to examine all attestations. For example, the third attestation may be executed, but a host and/or storage device may proceed independent of the result of this particular attestation.

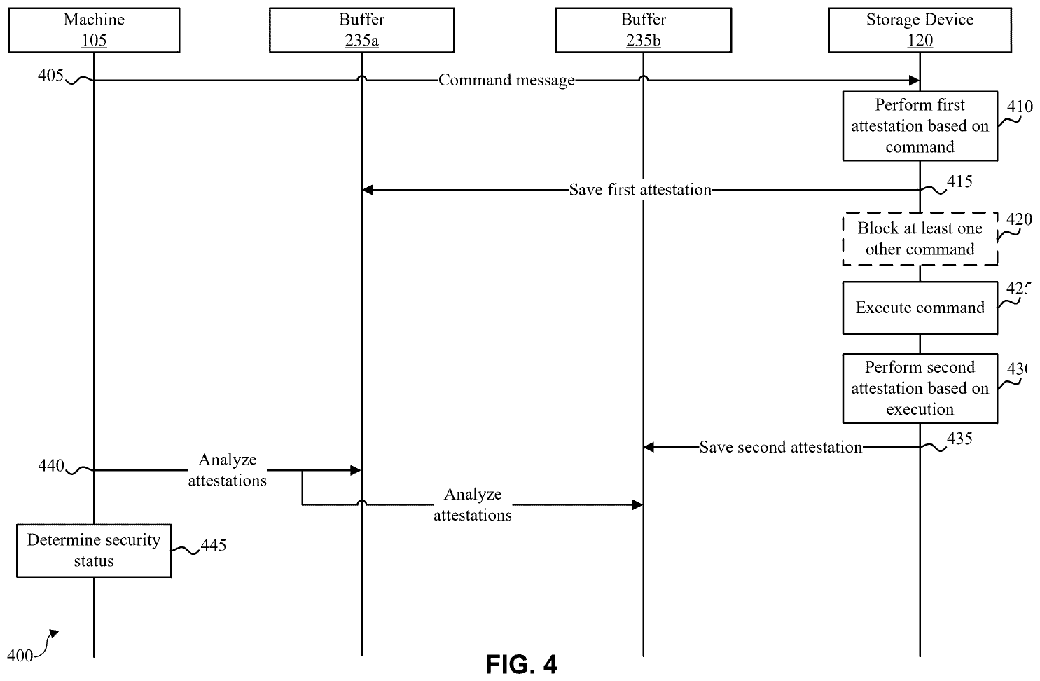

FIG. 4 illustrates an example system flow 400 in accordance with one or more implementations as described herein. In some configurations, one or more aspects of system flow 400 may be implemented by or in conjunction with attestation controller 140 of FIG. 1 and/or attestation controller 230 of FIG. 2. In some configurations, one or more aspects of system flow 400 may be implemented by or in conjunction with machine 105, components of machine 105, or any combination thereof. As shown, system flow 400 may include machine 105 (e.g., a host device), buffer 235a (e.g., a first buffer), buffer 235b (e.g., a second buffer), and storage device 120. In some cases, machine 105 may be a host of storage device 120. In some cases, machine 105 may include at least two buffers (e.g., attestation buffers) that include buffer 235a and buffer 235b.

At 405, machine 105 may send a command message to storage device 120. In some examples, the command may include a firmware update command, a sanitize command, etc.

At 410, storage device 120 may perform a first attestation based on the command. For example, in response to receiving the command from machine 105, storage device 120 may perform the first attestation.

At 415, storage device 120 may save the first attestation to buffer 235a (e.g., a first buffer of machine 105).

At 420, storage device 120 may optionally block at least one other command. For example, storage device 120 may block execution of one or more other commands while performing the first attestation, while saving the first attestation, while executing the command, and/or while performing one or more other attestations.

At 425, storage device 120 may execute the command from machine 105. For example, storage device 120 may perform a firmware update based on the command, perform a sanitization based on the command, etc.

At 430, storage device 120 may perform a second attestation based on executing the command. In some cases, one or more bits of the command and/or of a submission queue entry may indicate to perform the first attestation before executing the command and/or to perform the second attestation after executing the command.

At 435, storage device 120 may save the second attestation to buffer 235b (e.g., a second buffer of machine 105).

At 440, machine 105 may analyze one or more attestations. For example, machine 105 may access buffer 235a to analyze the first attestation and/or may access buffer 235b to analyze the second attestation, etc. For example, machine 105 may compare the first attestation to the second attestation to determine whether they match (e.g., indicating no potential compromise after executing the command such as a firmware update) or whether they differ (e.g., indicating storage device 120 is potentially compromised after executing the command).

At 445, machine 105 may determine a security status. For example, machine 105 may determine a security status of storage device 120 based on the analysis of one or more attestations at 440. Based on saving a first attestation to buffer 235a and a second attestation to buffer 235b, the systems and methods increase the security of storage device 120.

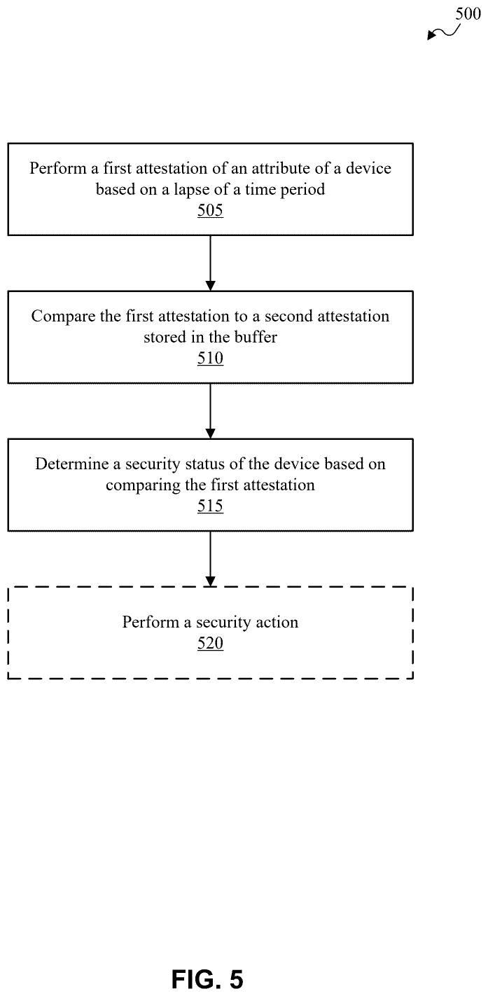

FIG. 5 depicts a flow diagram illustrating an example method 500 associated with the disclosed systems, in accordance with example implementations described herein. In some configurations, one or more aspects of method 500 may be implemented by or in conjunction with attestation controller 140 of FIG. 1 and/or attestation controller 230 of FIG. 2. In some configurations, one or more aspects of method 500 may be implemented by or in conjunction with machine 105, components of machine 105, or any combination thereof. In some cases, attestations based on the systems and methods described may involve a host (e.g., machine 105), an attestation server (e.g., a remote server communicatively coupled to the host), and a storage drive providing an attested snapshot (e.g., attested with a digital signature from the storage drive). The depicted method 500 is just one implementation and one or more operations of method 500 may be rearranged, reordered, omitted, and/or otherwise modified such that other implementations are possible and contemplated.

At 505, method 500 may include performing a first attestation of an attribute of a device based on a lapse of a configured time period. For example, a host (e.g., machine 105) may configure a storage drive (e.g., storage device 120) to perform attestations periodically. In some cases, the host may indicate the time period or periodicity. Alternatively, the storage drive may select the time period (e.g., a default time period). In some cases, the host or storage drive may adjust the time period (e.g., increase or decrease the time period based on a security level selected by the host). Accordingly, the storage drive may perform at least a first attestation based on being configured to perform periodic attestations.

At 510, method 500 may include comparing the first attestation to a second attestation stored in a buffer. For example, the storage drive and/or the host may analyze the first attestation in relation to the second attestation.

At 515, method 500 may include determining a security status of the device based on comparing the first attestation. For example, the storage drive and/or the host may determine a security status of the storage drive based on the analysis of the first attestation and the second attestation. The security status may indicate whether the storage drive is secure, remains secure, is compromised, whether a change has occurred to a firmware image of the storage drive, whether a change has occurred to a hardware component of the storage drive, whether a change has occurred to a software component of the storage drive, and/or whether a change has occurred to a setting of the storage drive. When an attestation or attestation analysis (e.g., attestation comparison) indicates a storage drive is potentially compromised, the storage drive may generate a notification and send the notification to a host of the storage drive. In some cases, the storage drive may limit or deactivate functionality (e.g., limit or deactivate read operations, write operations, allocations, and/or erase operations, etc.).

At 520, method 500 may optionally include performing a security action. For example, the storage drive and/or the host may perform a security action based on the security status (e.g., security status indicating the storage drive is compromised).

Accordingly, the systems and methods (e.g., method 500) may include performing one or more operations based on periodic attestation or continuous attestation logging. In some cases, the systems and methods may include determining a device (e.g., storage device 120) is powered on. A host may modify a device setting of a storage drive to activate periodic attestation or continuous attestation logging. In some cases, the device setting may persist over power cycles. Alternatively, the device setting may not persist over power cycles. As indicated, the storage drive may perform attestations every configured period of time (e.g., every day, every hour, every minute, etc.). In some cases, the host may preconfigure the time period. In some cases, the time period may be a default time period (e.g., every hour, every 6 hours etc.). In some cases, the host may update the default value to a host-selected time period. The systems and methods described improve storage device security based on improved attestation and authentication. The systems and methods enable attestation and authentication before and/or after a command of heightened security concern.

The storage drive may log one or more attestations in a buffer of the host (e.g., buffer 235). In some cases, the storage drive may do no additional attestations other than the periodic attestations, and may store attestation results when they are performed. Alternatively, the storage drive may perform one or more triggered attestations (e.g., triggered by commands such as firmware update, sanitize command, privilege commands, etc.) in addition to the periodic attestations.

In some examples, the storage drive may save each attestation in the buffer. In some cases, the storage drive may compare a previous attestation to a subsequent attestation. The storage drive may discard the previous attestation or the subsequent attestation when the subsequent attestation matches the previous attestation. The storage drive may store the subsequent attestation when the subsequent attestation does not match the previous attestation. In some cases, the storage drive may discard the previous attestation when the subsequent attestation is stored. The storage drive may keep the previous or the subsequent attestation to compare it to another subsequent attestation. In some cases, the storage device 120 may keep the second attestation for some time (e.g., indefinitely) or until an authorized changes such as a firmware update, which may result in an updated attestation.

In some cases, the host may access and query the storage drive attestation logs at any time. The host may verify that the storage drive has been continuously secure in all attestations. The host may verify whether the storage drive has had an insecure firmware version at any point in its history of deployment.

It is noted that the systems and methods may be performed for any command associated with a storage drive. In some examples, a command may include at least one activation bit that indicates whether to perform an attestation before and/or after a command. In some cases, a first activation bit may indicate whether to perform attestation before command execution (e.g., 0 indicates no attestation before execution, 1 indicates perform attestation before execution, or vice versa), and a second activation bit may indicate whether to perform attestation after command execution (e.g., 0 indicates no attestation after, 1 indicates perform attestation after, or vice versa). In some cases, a device setting of a storage drive may indicate attestation is to be performed before and/or after a list of commands included in the device setting (e.g., sanitize, firmware update, other data storage commands, etc.).

In some examples, a host may monitor attestation memory locations (set up an interrupt) to monitor one or more aspects of attestations. The one or more aspects of attestations may include at least one of the following: the progress of a current attestation; the progress of command execution; the risk of a later attestation overwrite in the same buffers previously provided; host buffers protecting against sudden SSD removal causing device power fail; etc. The buffers on the host may be consistent during this threat.

The systems and methods described herein include logic to provide leveraging multiple attestations to enable continuous storage drive security through discontinuous states. The logic includes any combination of hardware (e.g., at least one memory, at least one processor), logical circuitry, firmware, and/or software to provide leveraging of multiple attestations to enable continuous storage drive security through discontinuous states.

The systems and methods may include integrating attestations in a command's execution. Based on the systems and methods, no additional security commands are needed to trigger the attestation. In some cases, an attestation may be a non-interruptible attestation (e.g., the host may configure the storage drive to block the ability for peripheral unrelated commands to execute in between a given command and a corresponding attestation). Accordingly, based on the systems and methods described, continuous attestation provides secure channel continuity and secure methods of discovering whether a storage drive is running a firmware image that was discovered to introduce a security vulnerability.

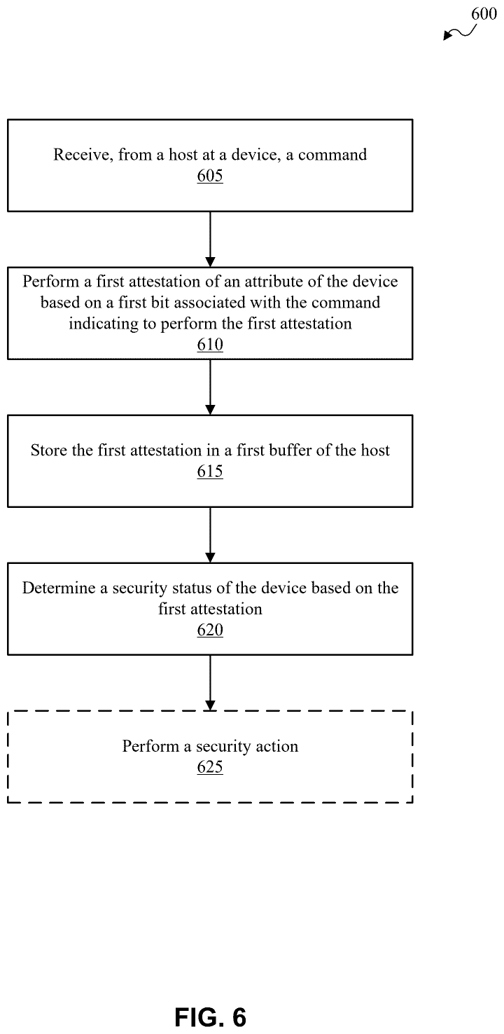

FIG. 6 depicts a flow diagram illustrating an example method 600 associated with the disclosed systems, in accordance with example implementations described herein. In some configurations, one or more aspects of method 600 may be implemented by or in conjunction with attestation controller 140 of FIG. 1 and/or attestation controller 230 of FIG. 2. In some configurations, one or more aspects of method 600 may be implemented by or in conjunction with machine 105, components of machine 105, or any combination thereof. The depicted method 600 is just one implementation and one or more operations of method 600 may be rearranged, reordered, omitted, and/or otherwise modified such that other implementations are possible and contemplated.

At 605, method 600 may include receiving, from a host at a device, a command. For example, a storage drive (e.g., storage device 120) may receive a command from a host (e.g., machine 105).

At 610, method 600 may include performing a first attestation of an attribute of the device based on a first bit associated with the command indicating to perform the first attestation. For example, the storage drive may perform a first attestation of an attribute of the device based on a first bit associated with the command indicating to perform the first attestation. In some cases, the command may include a first bit that indicates to perform the first attestation (e.g., before executing the command) and a second bit that indicates to perform a second attestation (e.g., after executing the command). In some cases, the command may include a third bit indicating to block at least one other command while performing the first attestation, while executing the command, and/or while executing the second attestation.

At 615, method 600 may include storing the first attestation in a first buffer of the host. For example, the storage drive may store the first attestation in a first buffer of the host.

At 620, method 600 may include determining a security status of the device based on the first attestation. For example, the host and/or the storage drive may determine a security status of the device based on the first attestation (e.g., based on an analysis or comparison of the first attestation to the second attestation). The storage drive may keep the previous or the subsequent attestation to compare it to another subsequent attestation. In some cases, the storage device 120 may keep the second attestation for some time (e.g., indefinitely) or until an authorized changes such as a firmware update, which may result in an updated attestation. The systems and methods described improve storage device security based on improved attestation and authentication. The systems and methods enable attestation and authentication before and/or after a command of heightened security concern.

At 625, method 500 may optionally include performing a security action. For example, the storage drive and/or the host may perform a security action based on the security status (e.g., security status indicating the storage drive is compromised).

In some examples, the systems and methods (e.g., method 600) may include performing one or more operations based on a firmware update, including performing attestation before and/or after the firmware update. The systems and methods may include a host determining a device (e.g., storage device 120) is running. The host may send a firmware image to the storage drive based on the host determining the storage drive is running (e.g., powered on and booted). The host may send a firmware update command to the storage drive. As discussed herein, storage drive may perform a first attestation into a first buffer provided by the host (e.g., a first buffer of the host).

In some cases, the storage drive may block one or more other command (e.g., all other commands) from executing on the storage drive (e.g., while the storage drive performs one or more attestations, while the storage drive executes the command, etc.). The storage drive may execute the firmware update and may block one or more other commands from executing (e.g., while the storage drive executes the firmware update). The storage drive may perform a second attestation into a second buffer provided by the host (e.g., a second buffer of the host). As the storage drive continues running, the host may verify the before and/or the after firmware images by examining the first attestation in the first buffer and/or examining the second attestation in the second buffer.

The systems and methods may include performing one or more operations based on the storage drive performing a sanitize command, including performing attestation before and/or after the sanitize command. In some cases, a host may send a sanitize command to the storage drive. The storage drive may perform a first attestation into a first buffer provided by the host (e.g., a first buffer of the host) based on receiving the sanitize command. The storage drive may be configured (e.g., preconfigured, configured by a message from the host) to block one or more other commands from executing on the storage drive (e.g., while the storage drive performs one or more attestations, while the storage drive executes the command, etc.). The storage drive may perform the sanitize command (e.g., based on performing the first attestation). In some cases, the storage drive may perform a second attestation into a second buffer provided by the host (e.g., a second buffer of the host). In some cases, the storage drive may perform the second attestation based on completing the sanitize command. In some cases, the first buffer and/or the second buffer may be on the storage drive. Alternatively, the first buffer and/or the second buffer may be stored on the host. In some cases, the first buffer and/or the second buffer may be stored remotely (e.g., in cloud storage).

In some examples, the storage drive may continue to run while the host verifies the expected attested firmware image that performed the sanitize command by examining the first attestation in the first buffer. When a second attestation is performed based on the sanitize command, the host may verify the expected attested firmware image based on examining the second attestation in the second buffer. In some cases, the host may compare or analyze the first attestation in relation to the second attestation.

In the examples described herein, the configurations and operations are example configurations and operations, and may involve various additional configurations and operations not explicitly illustrated. In some examples, one or more aspects of the illustrated configurations and/or operations may be omitted. In some embodiments, one or more of the operations may be performed by components other than those illustrated herein. Additionally, or alternatively, the sequential and/or temporal order of the operations may be varied.

Certain embodiments may be implemented in one or a combination of hardware, firmware, and software. Other embodiments may be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

The word “exemplary” is used herein to mean “serving as an example, instance, or illustration. ” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wired and/or wireless communication device such as a switch, router, network interface controller, cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be wireless, wired, mobile, and/or stationary.

As used within this document, the term “communicate” is intended to include transmitting, or receiving, or both transmitting and receiving. Similarly, the bidirectional exchange of data between two devices (both devices transmit and receive during the exchange) may be described as ‘communicating’, when only the functionality of one of those devices is being claimed. The term “communicating” as used herein with respect to wired and/or wireless communication signals includes transmitting the wired and/or wireless communication signals and/or receiving the wired and/or wireless communication signals. For example, a communication unit, which is capable of communicating wired and/or wireless communication signals, may include a wired/wireless transmitter to transmit communication signals to at least one other communication unit, and/or a wired/wireless communication receiver to receive the communication signal from at least one other communication unit.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infrared (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth™, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Although an example processing system has been described above, embodiments of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more components of computer program instructions, encoded on computer storage medium for execution by, or to control the operation of, information/data processing apparatus. Alternatively, or in addition, the program instructions can be encoded on an artificially-generated propagated signal, for example a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (for example multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example an FPGA (field programmable gate array) or an ASIC (application-specific integrated circuit). The apparatus can also include, in addition to hardware, code that creates an execution environment for the computer program in question, for example code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a component, component, subroutine, object, or other unit suitable for use in a computing environment. A computer program may, but need not, correspond to a file in a file system. A program can be stored in a portion of a file that holds other programs or information/data (for example one or more scripts stored in a markup language document), in a single file dedicated to the program in question, or in multiple coordinated files (for example files that store one or more components, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, for example magnetic, magneto-optical disks, or optical disks. However, a computer need not have such devices. Devices suitable for storing computer program instructions and information/data include all forms of non-volatile memory, media and memory devices, including by way of example semiconductor memory devices, for example EPROM, EEPROM, and flash memory devices; magnetic disks, for example internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, for example a CRT (cathode ray tube) or LCD (liquid crystal display) monitor, for displaying information/data to the user and a keyboard and a pointing device, for example a mouse or a trackball, by which the user can provide input to the computer. Other kinds of devices can be used to provide for interaction with a user as well; for example, feedback provided to the user can be any form of sensory feedback, for example visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, for example as an information/data server, or that includes a middleware component, for example an application server, or that includes a front-end component, for example a client computer having a graphical user interface or a web browser through which a user can interact with an embodiment of the subject matter described herein, or any combination of one or more such back-end, middleware, or front-end components. The components of the system can be interconnected by any form or medium of digital information/data communication, for example a communication network. Examples of communication networks include a local area network (“LAN”) and a wide area network (“WAN”), an inter-network (for example the Internet), and peer-to-peer networks (for example ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (for example an HTML page) to a client device (for example for purposes of displaying information/data to and receiving user input from a user interacting with the client device). Information/data generated at the client device (for example a result of the user interaction) can be received from the client device at the server.

While this specification contains many specific embodiment details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

Many modifications and other examples as set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. A method of persistent attestation, the method comprising:
performing a first attestation of an attribute of a device based on a lapse of a time period;
comparing the first attestation to a second attestation stored in a buffer;
determining a security status of the device based on comparing the first attestation; and
performing a security action based on the security status.

2. The method of claim 1, further comprising:
performing a third attestation based on a command received by the device; and
storing the third attestation in the buffer.

3. The method of claim 2, further comprising incorporating a transient value in at least one of the first attestation, the second attestation, or the third attestation.

4. The method of claim 2, further comprising:
comparing the third attestation to at least one of the first attestation or the second attestation; and
verifying the security status of the device based on comparing the third attestation, wherein the command comprises a bit that indicates to perform the third attestation.

5. The method of claim 2, wherein the command comprises at least one of a storage medium sanitize command, a dataset management deallocation command, a storage medium erase command, a storage medium format command, a data read command, a data write command, a virtualization command, a non-volatile memory administrative command, a controller data queue command, a migration receive command, a migration send command, a track send command, or a track receive command.

6. The method of claim 1, wherein the security action comprises at least one of preventing the device from performing an action, isolating at least a portion of the device, limiting access to at least a portion of the device, deactivating at least one hardware component of the device, deactivating at least one software component of the device, or alerting an administrator the device is potentially compromised.

7. The method of claim 1, further comprising discarding the first attestation based on a determination that the first attestation matches the second attestation.

8. The method of claim 1, further comprising storing the first attestation in the buffer based on a determination that the first attestation mismatches the second attestation.

9. The method of claim 1, wherein the attribute of the device comprises at least one of an aspect of a device hardware component, an aspect of a device software component, or a device setting.

10. The method of claim 1, wherein:
a host of the device comprises the buffer,
the device comprises a storage drive, and
performing the first attestation is based on receiving, at the device, an activation command from the host, the activation command activating periodic attestation on the device and indicating the time period.

11. A method of persistent attestation, the method comprising:
receiving, from a host at a device, a command;
performing a first attestation of an attribute of the device based on a first bit associated with the command indicating to perform the first attestation;
storing the first attestation in a first buffer;
determining a security status of the device based on the first attestation; and
performing a security action based on the security status.

12. The method of claim 11, further comprising:
performing a second attestation of the attribute of the device based on executing the command; and
storing the second attestation in a second buffer, wherein determining the security status is based on comparing the first attestation to the second attestation.

13. The method of claim 12, further comprising incorporating a transient value in at least one of the first attestation or the second attestation, wherein the host or the device comprises the first buffer, and the host or the device comprises the second buffer.

14. The method of claim 12, wherein the command or a submission queue entry associated with the command comprises the first bit that indicates to perform the first attestation and a second bit that indicates to perform the second attestation.

15. The method of claim 12, further comprising blocking at least one other command at the device based on at least one of performing the first attestation, executing the command, or performing the second attestation, wherein the command comprises a third bit indicating to block the at least one other command.

16. The method of claim 12, wherein:
the command comprises a sanitize command, and
determining the security status of the device comprises verifying, based on the comparing, a firmware image associated with executing the sanitize command.

17. The method of claim 11, wherein:
the command comprises a firmware update command, and
executing the command comprises installing a firmware image on the device, the host sending the firmware image to the device with the firmware update command.

18. The method of claim 11, wherein the attribute of the device comprises at least one of an aspect of a device hardware component, an aspect of a device software component, or a device setting.

19. A non-transitory computer-readable medium storing code that comprises instructions executable by a processor to:
perform a first attestation of an attribute of a device based on a lapse of time period;
compare the first attestation to a second attestation stored in a buffer; and
determine a security status of the device based on comparing the first attestation; and
perform a security action based on the security status.

20. The non-transitory computer-readable medium of claim 19, wherein the code includes further instructions executable by the processor to:
perform a third attestation based on a command received by the device;
store the third attestation in the buffer; and
incorporate a transient value in at least one of the first attestation, the second attestation, or the third attestation.
